(19) United States
(12) Patent Application Publication
(10) Pub. No.: US 2025/0178225 A1
(43) Pub. Date: Jun. 5, 2025

(54) COUPLING MECHANISM FOR A SHAVING DEVICE

(71) Applicant: BIC Violex Single Member S.A., Anoixi (GR)

(72) Inventor: Panagiotis KOPELAS, Anoixi (GR)

(73) Assignee: BIC Violex Single Member S.A., Anoixi (GR)

(21) Appl. No.: 18/715,521

(22) PCT Filed: Dec. 2, 2022
(86) PCT No.: PCT/EP2022/084252

§ 371 Date: May 31, 2024

(30) Foreign Application Priority Data
Dec. 22, 2021 (EP) 21217084.9

(51) Int. Cl. B26B 21/52; B26B 21/22; B26B 21/40

(52) U.S. Cl. CPC B26B 21/521; B26B 21/225; B26B 21/4062; B26B 21/522

(57) ABSTRACT

A coupling mechanism including a first coupling member configured to move between a first position and a second position and a second coupling member configured to move relative to the first coupling member between a first position and a second position, and the second coupling member being configured to cause the first coupling member to move from the first position toward the second position when the second coupling member moves from the first position toward the second position, wherein, the first coupling member is configured to move from the second position to the first position when the second coupling member is in the second position, and the first coupling member is configured to secure a coupling between the first coupling member and the second coupling member when the second coupling member is in the second position and the first coupling member is in the first position.

### CROSS-REFERENCE TO RELATED APPLICATION

This is a National Stage Application under 35 U.S.C. § 371 of International Application No. PCT/EP2022/084252, filed on Dec. 2, 2022, now published as WO 2023/117375 A1, which claims priority to European patent application EP 21217084.9 filed Dec. 22, 2021 the entireties of which are incorporated herein by reference.

### FIELD

The present disclosure relates generally to the field of skincare, and in particular to shaving. More specifically, the present disclosure relates to a coupling mechanism for connecting a replaceable shaving cartridge of a shaving device to a handle of the shaving device.

### BACKGROUND

A typical handheld shaving device includes a handle and replaceable shaving cartridges and/or heads that are configured to connect to the handle via a coupling mechanism. The coupling mechanism should allow for engagement and disengagement of the shaving cartridge to and from the handle. However, many presently available coupling mechanisms employ complex configurations, which include an excessive amount of components. Including an excessive amount of components results in increased modes of failure, increased costs in manufacture, and/or complicated functionality.

It is desirable to provide an improved coupling mechanism for engaging and disengaging a shaving cartridge of a shaving device to a handle of the shaving device, in a manner which reduces a number of components of the coupling mechanism and simplifies functionality and/or manufacture of the coupling mechanism.

### SUMMARY

According to aspects of the disclosure, a coupling mechanism for a shaving device is provided. The coupling mechanism includes a first coupling member being configured to move between a first coupling member first position and a first coupling member second position and a second coupling member being configured to move relative to the first coupling member between a second coupling member first position and a second coupling member second position, and the second coupling member being configured to cause the first coupling member to move from the first coupling member first position toward the first coupling member second position when the second coupling member moves relative to the first coupling member from the second coupling member first position toward the second coupling member second position, wherein, the first coupling member is configured to move from the first coupling member second position to the first coupling member first position when the second coupling member is in the second coupling member second position, and the first coupling member is configured to secure a coupling between the first coupling member and the second coupling member when the second coupling member is in the second coupling member second position and the first coupling member is in the first coupling member first position.

According to aspects of the disclosure, the first coupling member may include a bias member being configured to bias the first coupling member toward the first coupling member first position.

According to aspects of the disclosure, the second coupling member may include a ramp extending from a root to an edge, the ramp being configured to contact the first coupling member when the second coupling member moves relative to the first coupling member between the second coupling member first position and the second coupling member second position

According to aspects of the disclosure, movement of the first coupling member along the ramp from the root toward the edge may cause the first coupling member to move from the first coupling member first position toward the first coupling member second position.

According to aspects of the disclosure, the first coupling member may be configured to abut the edge of the ramp to guide the coupling between the first coupling member and the second coupling member when the second coupling member is in the second coupling member second position and the first coupling member is in the first coupling member first position.

According to aspects of the disclosure, the second coupling member may include a frame including the ramp and the ramp extends from a surface of the frame toward a center of the frame.

According to aspects of the disclosure, the frame may include a leading surface and a trailing surface opposing the leading surface, the leading surface and the trailing surface may be connected to each other by a first sidewall surface and a second sidewall surface, and the ramp may be oriented at an angle within a range of 0 degrees and 50 degrees with respect to the first sidewall surface and/or the second sidewall surface.

According to aspects of the disclosure, the coupling mechanism according to any aspect disclosed herein may include a third coupling member configured to support the second coupling member.

According to aspects of the disclosure, the second coupling member may be configured to move between the second coupling first position and the second coupling member second position on the third coupling member.

According to aspects of the disclosure, the third coupling member may be pivotable with respect to the first coupling member.

According to aspects of the disclosure, the third coupling member may include a bias member being configured to bias the second coupling member toward the second coupling member first position.

According to aspects of the disclosure, the second coupling member may include an engagement member being configured to engage the first coupling member when the first coupling member is in the first coupling member first position and the second coupling member is in the second coupling member second position.

According to aspects of the disclosure, the coupling mechanism according to any aspect of the disclosure herein may include a button being configured to be manipulated by a user and to move the first coupling member between the first coupling member first position and the first coupling member second position.

According to aspects of the disclosure, a shaving device is provided. The shaving device includes the coupling mechanism according to any aspect disclosed herein, a shaving head, and a handle, wherein, the handle includes the first coupling member of the coupling mechanism and the shaving head includes the second coupling member of the coupling mechanism.

In the manner described and according to aspects illustrated herein, the coupling mechanism and the shaving device are capable of engaging and disengaging a shaving cartridge of a shaving device to a handle of the shaving device, in a manner which reduces a number of components of the coupling mechanism and simplifies functionality and/or manufacture of the coupling mechanism.

### BRIEF DESCRIPTION OF THE DRAWINGS

Aspects of an embodiment will be described in reference to the drawings, where like numerals reflect like elements:

FIG. 1 is an exploded view of a coupling mechanism of a shaving device according to aspects of the disclosure;

FIG. 2 is a perspective view of a first coupling member and a third coupling member of the coupling mechanism according to FIG. 1;

FIG. 3 is a cross-sectional view of the first coupling member and the third coupling member of the coupling mechanism according to FIG. 1;

FIG. 4 is a perspective view of a second coupling member of the coupling mechanism according to FIG. 1;

FIG. 5 is a perspective view of the coupling mechanism according to FIG. 1;

FIG. 6 is a perspective view of the coupling mechanism according to FIG. 1;

FIG. 7 is a cross-sectional view of the coupling mechanism according to FIG. 1;

FIG. 8 is a cross-sectional view of the coupling mechanism according to FIG. 1;

FIG. 9 is a cross-sectional view of the coupling mechanism according to FIG. 1;

FIG. 10 is a cross-sectional view of the coupling mechanism according to FIG. 1;

FIG. 11 is a perspective view of the coupling mechanism according to FIG. 1;

FIG. 12 is a cross-sectional view of the coupling mechanism according to FIG. 1; and

FIG. 13 is a perspective view of the coupling mechanism according to FIG. 1, showing an alternative example of the third coupling member according to aspects of the disclosure;

### DETAILED DESCRIPTION

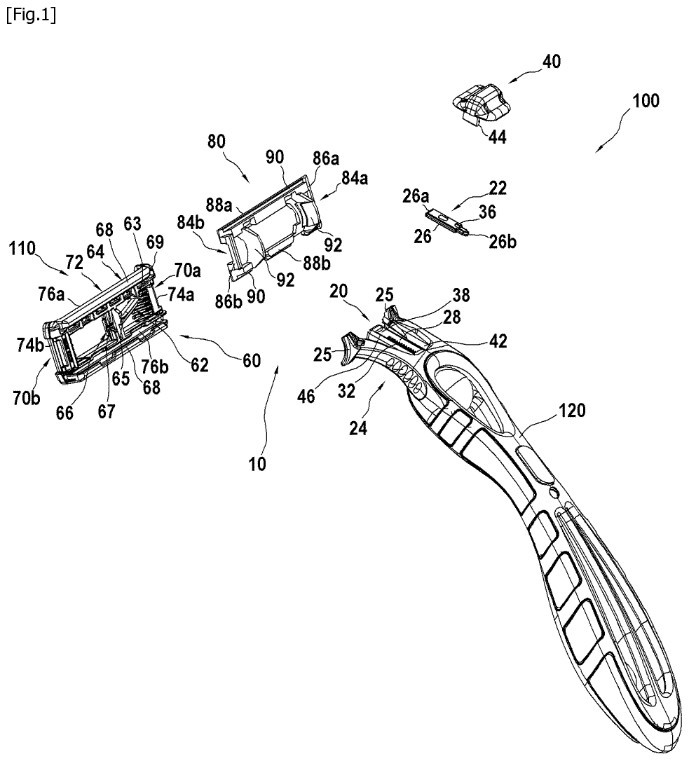

An embodiment of a coupling mechanism for a shaving device according to aspects of the disclosure will now be described with reference to FIGS. 1-13, wherein like numerals represent like parts, and will generally be referred to by the reference numeral 10. Although the coupling mechanism 10 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

As shown in FIG. 1, the coupling mechanism 10 is configured to couple parts of a shaving device 100. The shaving device 100 includes a head (also referred to herein as a “replaceable shaving cartridge”) 110 and a handle 120. It is contemplated that the head 110 of the shaving device 100 is configured for shaving a body part (e.g. a face, arm, leg, and/or the like) of a user. Accordingly, the head 110 of the shaving device 100 may include a plurality of blades (not shown) manufactured from sheet metal and/or the like extending across the head 110 of the shaving device 100. Additionally, it is contemplated that the handle 120 of the shaving device 100 is configured to be held by a hand of the user. Accordingly, the handle 120 of the shaving device 100 may include an elongated, ergonomic shape corresponding to the hand of the user. Further, it is contemplated that aspects of the coupling mechanism 10 may be included on and/or form part of the head 110 and/or the handle 120 of the shaving device 100 (discussed further below). Accordingly, the coupling mechanism 10 may be considered to be part of the shaving device 100.

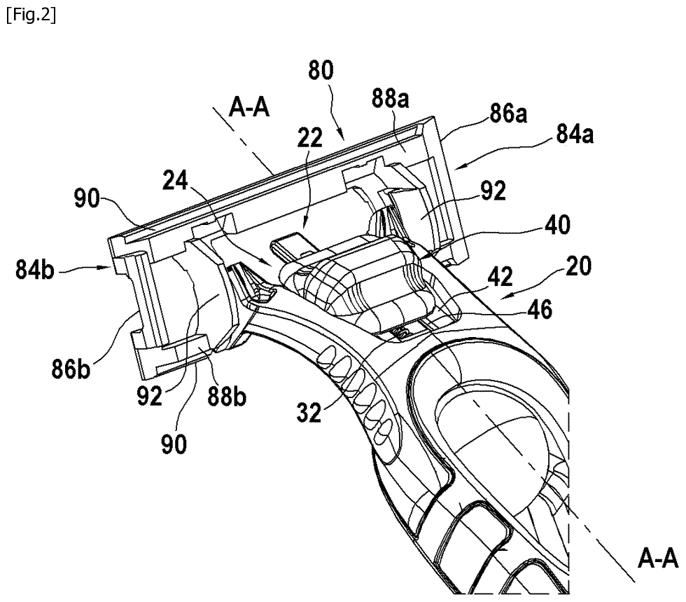

As shown in FIGS. 2-3 and 10-12, the coupling mechanism 10 is bisected by an axis A-A and includes a first coupling member (also may be referred to herein as a “locking member”) 20, a second coupling member 60, and a third coupling member 80 configured to allow for engagement and disengagement of the head 110 of the shaving device 100 to and from the handle 120 of the shaving device 100, in a manner that reduces a number of components employed by the coupling mechanism 10 and that simplifies the functionality and/or manufacture of the coupling mechanism 10.

As shown in FIGS. 2-6, the first coupling member 20 is configured to engage and disengage the second coupling member 60. To this end, the first coupling member 20 includes a projection 22 configured to contact the second coupling member 60 and a base 24 configured to support the projection 22. Referring to FIG. 1, the base 24 and, thus, the first coupling member 20, may be configured to connect to the handle 120 of the shaving device 100. Additionally or alternatively, the base 24 may be part of the handle 120 of the shaving device 100. To this end, the base 24 may be integrally formed with the handle 120 of the shaving device 100. Configuring the base 24 to be connected to and/or part of the handle 120 of the shaving device 100 allows for a user to reuse the handle 120 of the shaving device 100, while being able to replace the head 110 of the shaving device 100.

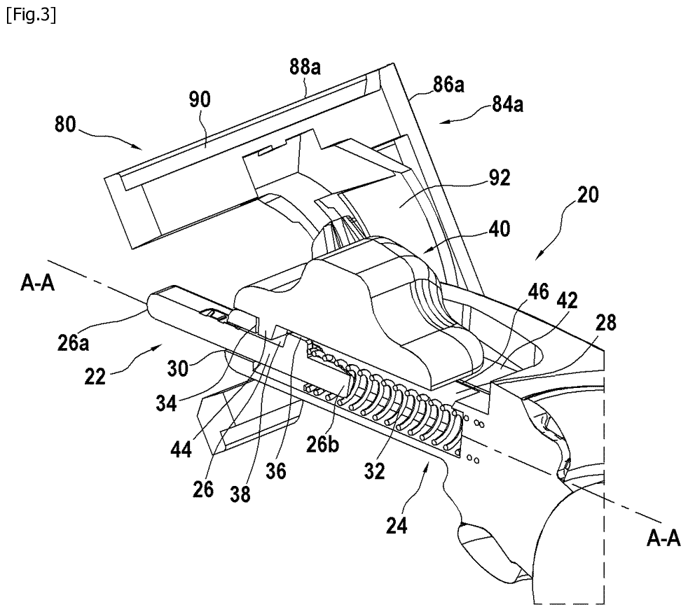

Referring to FIGS. 2-3, the projection 22 includes a body 26 extending between a first end 26a and a second end 26b, with the first end 26a of the projection 22 being configured to contact the second coupling member 60 and the second end 26b of the projection 22 being configured to be received by the base 24 to support the projection 22. To this end, the base 24 defines a chamber 28 configured to receive the second end 26b of the projection 22. In examples, the base 24 defines an opening 30 in communication with the chamber 28 configured to allow the first end 26a of the projection 22 to extend out of the base 24. In examples, the projection 22 is in the form of an elongated post. Providing the projection 22 in the form of an elongated post allows for the projection 22 to contact and/or interact with the second coupling member 60, without increasing the amount of space occupied by the first coupling member 20 within the coupling mechanism 10, thereby further allowing for reduction of an amount of components used and/or simplification of the functionality and/or the manufacture of the coupling mechanism 10. In examples, the projection 22 and the chamber 28 may be arranged along the axis A-A. Arranging the projection 22 and the chamber 28 along the axis A-A allows the projection 22 to realize a position that corresponds to a center 72 of the second coupling member 60 (discussed further below).

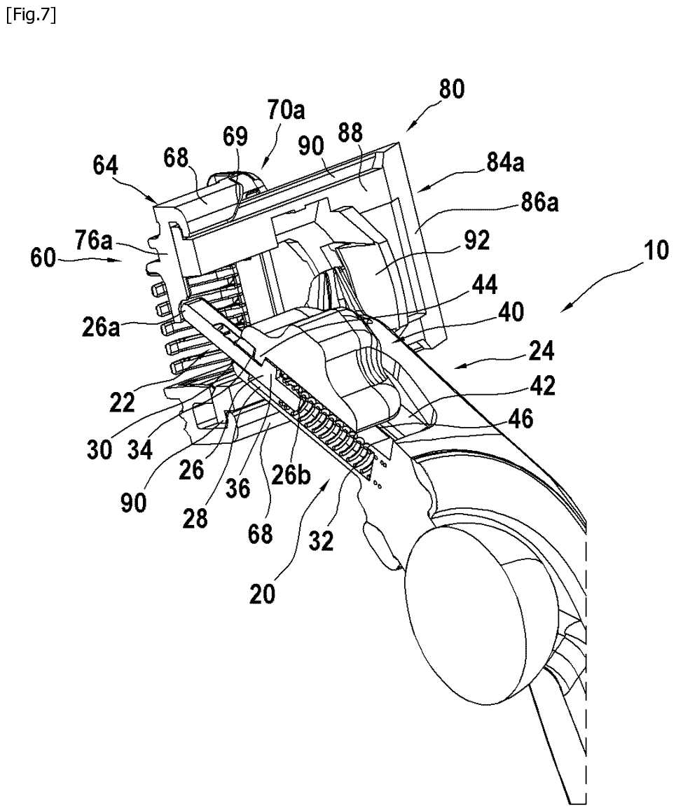

As illustrated by FIGS. 7-10, the first coupling member 20 is configured to move and/or be moved between a first coupling member first position and a first coupling member second position. In particular, the projection 22 of the first coupling member 20 is configured to move and/or be moved axially between the first coupling member first position and the first coupling member second position, in a first direction toward the first coupling member first position and a second direction toward the first coupling member second position. In the first coupling member first position, the first end 26a of the projection 22 is fully extended out of the opening 30 of the base 24 and capable of securing a coupling between the first coupling member 20, the second coupling member 60, and the third coupling member 80. In the first coupling member second position, the projection 22 is at least partially retracted within the base 24 and incapable of securing the coupling between the first coupling member 20 the second coupling member 60, and the third coupling member 80.

Referring to FIGS. 2-3, the projection 22 is biased toward the first coupling member first position. To this end, the first coupling member 20 may include a bias member 32. The bias member 32 is configured to apply a biasing force on the second end 26b of the projection 22. As such, the bias member 32 may be arranged within the chamber 28 of the first coupling member 20, between the projection 22 and an inner wall 34 extending throughout the base 24. In examples, the bias member 32 is a coil spring; however, it is contemplated that other bias members may be compatible with the coupling mechanism 10. In examples, the projection 22 may include a shoulder 36 extending from the body 26 of the projection 22 between the first end 26a and the second end of the projection 22. The shoulder 36 is configured to receive the biasing force from the bias member 32. The shoulder 36 of the projection 22 may also be configured to stop movement of the projection 22 within the chamber 28 of the base 24. To this end, the base 24 defines a space 38 in communication with the chamber 28 configured to receive the shoulder 34 of the projection 22. The inner wall 34 of the base 24, within the space 38 of the base 24, is configured to obstruct the shoulder 36 of the projection 22 to limit movement of the projection 22 in the first direction. In this manner, the projection 22 only extends out of the base 24 until the shoulder 36 is obstructed by the inner wall 34 of the base 24 within the space 38 of the base 24. Additionally, in this manner, the projection 22 is secured within the base 24.

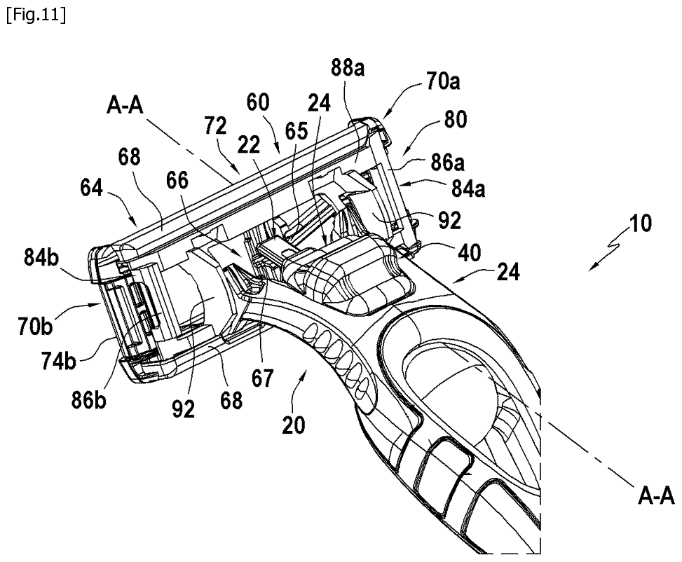

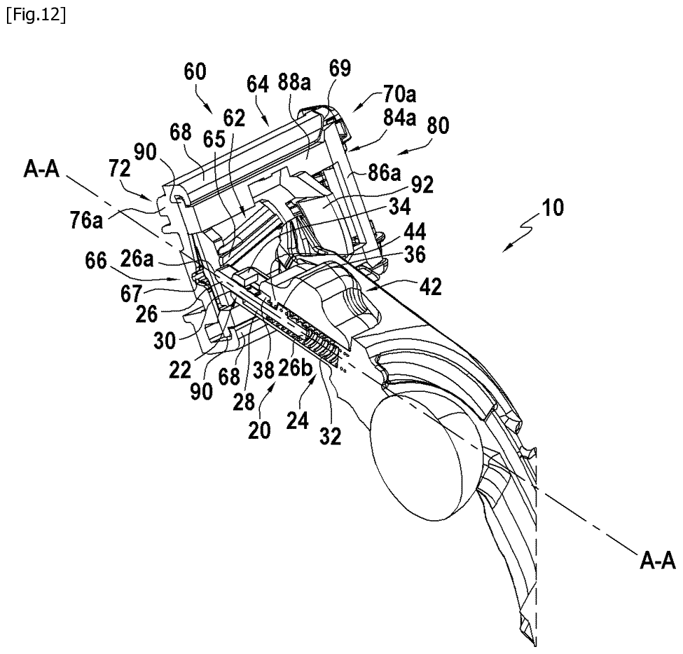

Referring to FIGS. 2-3, the first coupling member 20 may include a button 40 configured to move the first coupling member 20 between the first coupling member first position and the first coupling member second position. In particular, the button 40 is configured to move the projection 22 of the first coupling member 20 between the first coupling member first position and the first coupling member second position. In examples, the button 40 is configured to be moved and/or manipulated by the user of the coupling mechanism 10. To this end, at least a portion of the button 40 is oriented on an outer wall 42 of the base 24 of the first coupling member 20. Referring to FIGS. 3, 6, and 10-12, the button 40 is configured to engage the projection 22 to move the projection 22 between the first coupling member first position and the first coupling member second position. To this end, the button 40 may include a shoulder 44 complimentary to the shoulder 36 of the projection 22. In examples, the outer surface 42 of the base 24 defines a second opening 46 in communication with the space 38. As such, the space 38 of the base 24 is configured to receive the shoulder 44 of the button 40. In this manner, the shoulder 44 of the button 40 extends into the space 38 to engage the shoulder 36 of the projection 22. Further, as illustrated by FIGS. 11-12, movement of the button 40 in the second direction of the projection 22 moves the projection 22 toward the first coupling member second position. In this manner, the button 40 is configured for decoupling the first coupling member 20 and the second coupling member 60 and, thus, the head 110 and the handle 120 of the shaving device 100 (discussed further below).

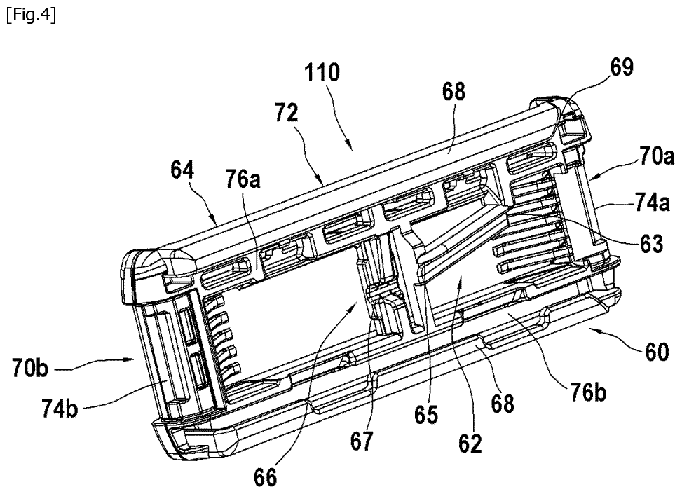

As shown in FIGS. 4-6, the second coupling member 60 may be configured to engage and disengage the first coupling member 20. In particular, the second coupling member 60 is configured to engage and disengage the first coupling member 20 and the third coupling member 80. To this end, the second coupling member 60 may include a ramp 62 configured to contact the first coupling member 20, a frame 64 configured to support the ramp 62, an engagement member 66 configured to engage the first coupling member 20, and a guide member 68 configured to engage the third coupling member 80. Referring to FIGS. 1 and 4, the frame 64 and, thus, the second coupling member 60 may be configured to connect to the head 110 of the shaving device 100. Additionally or alternatively, the frame 64 may be part of the head 110 of the shaving device 100. To this end, the frame 64 may be integrally formed with and/or constructed as the head 110 of the shaving device 100. Configuring the frame 64 to be connected to and/or part of the head 110 of the shaving device 100 allows for the user to reuse the handle 120 of the shaving device 100, while being able to replace the head 110 of the shaving device 100.

Referring to FIG. 4, the frame 64 of the second coupling member 60 extends between a first end 70a and a second end 70b and includes a center 72 therebetween. In particular, the frame 64 may include a first sidewall (surface) 74a at the first end 70a of the frame 64, a second sidewall (surface) 74b at the second end 70b of the frame 64, a first lateral wall 76a (also referred to herein as a “trailing surface”) extending between the first and second sidewalls 74a, 74b of the frame 64, and a second lateral wall 76b (also referred to herein as a “leading surface”) extending between the first and second sidewalls 74a, 74b of the frame 64. In examples, the frame 64 may be configured such that the center 72 of the frame 64 aligns with the axis A-A when the second coupling member 60 is coupled to the first coupling member 20. The frame 64 being configured such that the center 72 of the frame 64 aligns with the axis A-A when the second coupling member 60 is coupled to the first coupling member 20 allows the projection 22, which is arranged along the axis A-A, to secure the coupling between the first coupling member 20, the second coupling member 60, and the third coupling member 80 (discussed further below).

In examples, the ramp 62 of the second coupling member 60 may extend between the first end 70a and the second end 70b of the frame 64. In particular, the ramp 62 may extend from a position at or adjacent to the first end 70a and, thus, the first sidewall 74a of the frame 64, toward a position at or adjacent to the center 72 of the frame 64. More in particular, the ramp 62 may extend from a root 63 at or adjacent to the first end 70a and, thus, the first sidewall 74a of the frame 64, to an edge 65 at or adjacent to the center 72 of the frame 64. The ramp 62 extending to the position at or adjacent to the center 72 of the frame 64 further allows the projection 22, which is arranged along the axis A-A, to secure the coupling between the first coupling member 20, the second coupling member 60, and the third coupling member 80. In examples, the ramp 62 is configured to extend from the root 63 to the edge 65 at an angle within a range of 0 degrees to 50 degrees with respect to the first sidewall 74a and/or the second sidewall 74b and/or a plane of movement of the second coupling member 60 in the first direction. In particular, the ramp 62 may extend from the root 63 to the edge 65 at an angle of 12 degrees with respect to the first sidewall 74a and/or the second sidewall 74b and/or the plane of movement of the second coupling member 60 in the first direction. Additionally or alternatively, the ramp 62 is configured to extend from the root 63 to the edge 65 at an angle within a range of 0 degrees to 50 degrees with respect to the first lateral wall 76a and/or a plane of movement of the second coupling member 60 in the first direction. In particular, the ramp 62 may extend from the root 63 to the edge 65 at an angle of 7.5 degrees with respect to the first lateral wall 76a and/or the plane of movement of the second coupling member 60 in the first direction. By configuring the ramp 62 to extend at an angle, the edge 65 of the ramp 62 is oriented at an inward position relative to the root 63 of the ramp 62 and the engagement member 66. It is contemplated that the term “inward” as used herein may be understood to be a position closer to the base 24 of the first coupling member 20 when the second coupling member 60 is engaged with the first coupling member 20 and the third coupling member 80. Additionally or alternatively, it is contemplated that the term “inward” as used herein may be understood to be a direction corresponding to the second direction of the projection 22. Accordingly, contact between the projection 22 of the first coupling member 20 and the ramp 62 of the second coupling member 60, between the root 63 of the ramp 62 and the edge 65 of the ramp 62, causes the projection 22 to move inwardly and/or in the second direction toward the first coupling member second position (discussed further below). In examples, when the projection 22 reaches the edge 65 of the ramp 62, and is then no longer in contact with the ramp 62, the projection 22 moves in the first direction toward the first coupling member first position, overshooting the ramp 62 to engage the engagement member 66 of the second coupling member 60 (discussed further below). Further, since the edge 65 of the ramp 62 of the second coupling member 60 is inward of the engagement member 66 of the second coupling member 60, the body 26 of the projection 22 abuts the edge 65 of the ramp 62 when the projection 22 is in the first coupling member first position and the second coupling member is in the second coupling member second position, thereby obstructing movement of the second coupling member 60 in a second direction toward a second coupling member first position (discussed further below).

In examples and as illustrated by FIGS. 4-10, the second coupling member 60 may be configured to move and/or be moved relative to the first coupling member 20. In particular, the second coupling member 10 is configured to move and/or be moved relative to the first coupling member 20 between a second coupling member first position and a second coupling member second position. More in particular, the frame 64 and, thus, the ramp 62 and the engagement member 66 of the second coupling member 60 are configured to move and/or be moved perpendicular to the axis A-A, relative to the first coupling member 20 between the second coupling member first position and the second coupling member second position, in a first direction toward the second coupling member second position and a second direction toward the second coupling member first position.

In examples, the second coupling member 60 may be configured to move and/or be moved slidably between the second coupling member first position and the second coupling member second position through engagement of the guide member 68 of the second coupling member 60 and a complimentary element (i.e. a flange 90 of the third coupling member 80—discussed further below) of the third coupling member 80. In examples, the second coupling member 60 includes a pair of opposing guide members 68 extending along the first lateral wall 76a and the second lateral wall 76b of the second coupling member 60, respectively, between the first end 70a and the second end 70b of the second coupling member 60. Further, the guide members 68 are configured to receive the complimentary element 90 of the third coupling member 80. To this end, the first end 70a of the second coupling member 60 defines a pair of apertures 69, each in communication with a corresponding guide member 68, configured to receive the complimentary element 90 of the third coupling member 80. The apertures 69 of the second coupling member 60 are included at the first end 70a of the second coupling member 60 such that contact between the projection 22 of the first coupling member 20 and the ramp 62 of the second coupling member 60 begins at the root 63 of the ramp 62 of the second coupling member 60. In this manner, the projection 22 of the first coupling member 20 may be moved in the second direction toward the first coupling member second position as the first end 26a of the projection 22 slides upon an increasing angle of the ramp 62, from the root 63 of the ramp 62 to the edge 65 of the ramp 62.

In examples, in the second coupling member first position, the engagement member 66 of the second coupling member 60 may be unaligned with the axis A-A and, thus, the projection 22 of the first coupling member 20 is incapable of securing the coupling between the first coupling member 20, the second coupling member 60, and the third coupling member 80. In the second coupling member second position, the engagement member 66 of the second coupling member 60 may be aligned with the axis A-A and, thus, the projection 22 of the first coupling member 20 is capable of securing the coupling between the first coupling member 20, the second coupling member 60, and the third coupling member 80. Accordingly, the engagement member 66 of the second coupling member 60 may be included at the center 72 of the second coupling member 60. In an example, the second coupling member 60 may include a recess 67 configured to receive the first end 26a of the projection 22 of the first coupling member 20. In this manner, the engagement member 66 of the second coupling member 60 may engage the projection 22 of the first coupling member 20 when the first coupling member 20 is in the first coupling member first position and the second coupling member 60 is in the second coupling member second position (discussed further below).

In examples, the second coupling member 60 may be configured to be supported by the third coupling member 80. Accordingly, the second coupling member 60 is configured to move and/or be moved between the second coupling member first position and the second coupling member second position on the third coupling member 80. To this end, the third coupling member 80 may be configured to connect to the first coupling member 20. In particular, the third coupling member 80 may be configured to connect to the base 24 of the first coupling member 20. As such, it is contemplated that the third coupling member 80 may be understood as being part of the base 24 of the first coupling member 20.

In examples, the third coupling member 80 may include a platform 82 extending between a first end 84a and a second end 84b. In particular, the platform 82 of the third coupling member 80 may include a first sidewall 86a at the first end 84a of the platform 82 corresponding to the first sidewall 74a of the frame 64 of the second coupling member 60, a second sidewall 86b at the second end 84b of the platform 82 corresponding to the second sidewall 74b of the frame 64 of the second coupling member 60, a first lateral wall 88a extending between the first and second sidewalls 86a, 86b of the platform 82 corresponding to the first lateral wall 76a of the frame 64 of the second coupling member 60, and a second lateral wall 88b extending between the first and second sidewalls 86a, 86b of the platform 82 corresponding to the second lateral wall 76b of the frame 64 of the second coupling member 60. In an example, the third coupling member 80 may include a flange 90 configured to engage and/or be received within the guide member 68 of the second coupling member 60. In particular, the third coupling member 80 may include a pair of opposing flanges 90 extending along the first lateral wall 88a and the second lateral 88b, respectively, between the first end 84a and the second end 84b of the third coupling member 80. In this manner, the guide members 68 of the second coupling member 60 are configured to move and/or be moved along the flanges 90 of the third coupling member 80. In examples, the third coupling member 80 is configured to be pivotable. To this end, the third coupling member 80 may include a pair of opposing pivot members 92 bisected by the axis A-A. Additionally or alternatively, the pivot members of the third coupling member 80 may be configured to connect with a complimentary support member 25 included by the first coupling member 20 (see FIG. 1). In this manner, the third coupling member 80 is connected to the first coupling member 20, and pivotable about the first coupling member 20.

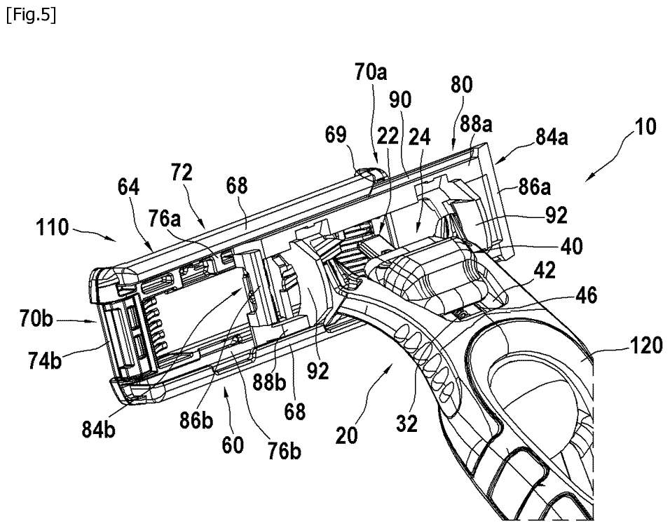

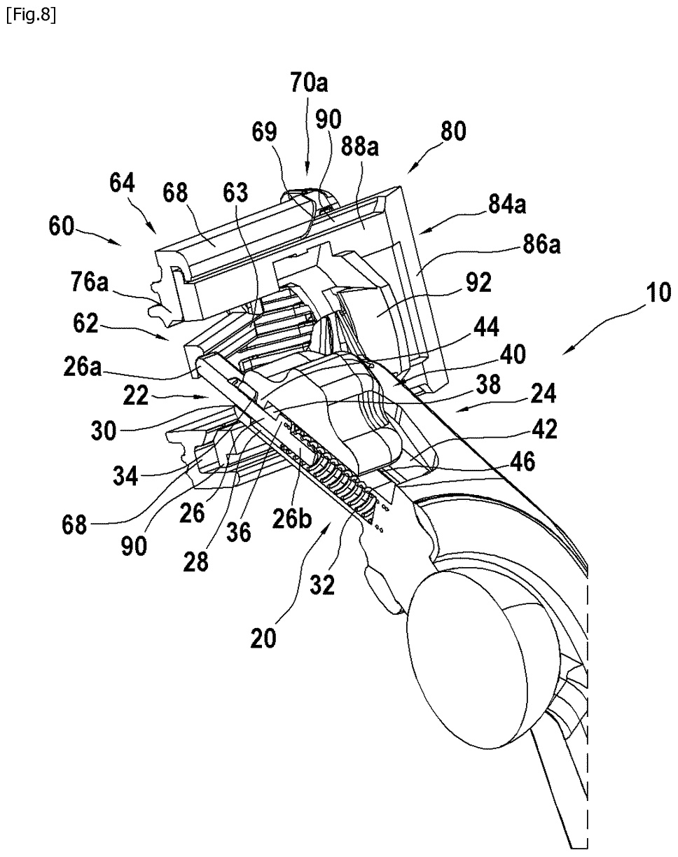

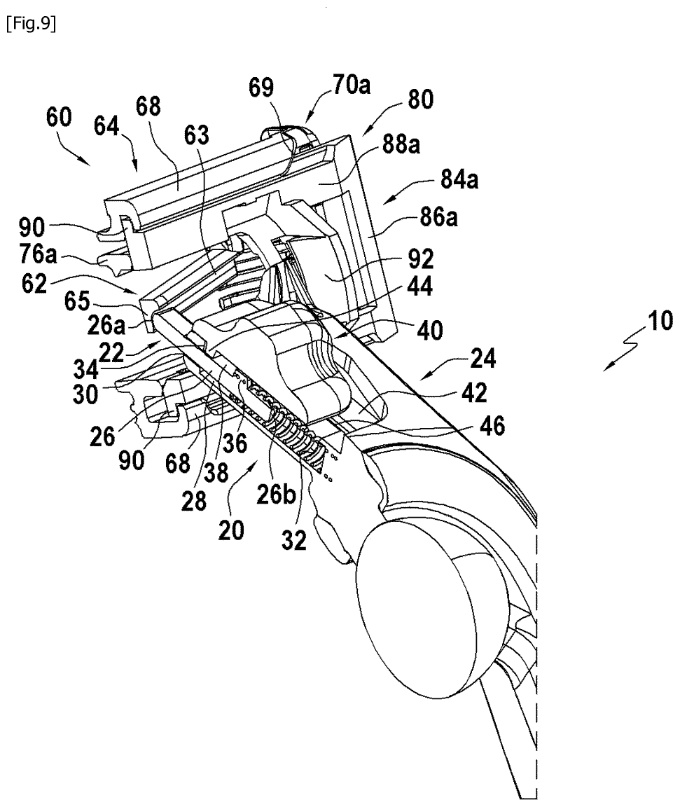

In examples and as illustrated by FIGS. 5-10, the user may couple the second coupling member 60 to the first coupling member 20 and the third coupling member 80. Referring to FIGS. 5 and 7, to secure the coupling, the user positions the first end 70a of the second coupling member 60 at the second end 84b of the third coupling member 80, such that the flanges 90 of the third coupling member 80 are inserted into and/or received by the apertures 69 defined by the frame 64 of the second coupling member 60. The user then moves the second coupling member 60 in the first direction of the second coupling member 60, from the second coupling member first position toward the second coupling member second position. As the second coupling member 60 moves toward the second coupling member second position, in the first direction of the second coupling member 60, the first end 26a of the projection 22 of the first coupling member 20 comes into contact with the root 63 of the ramp 62 of the second coupling member 60. Referring to FIGS. 8-9, as the second coupling member 60 moves further toward the second coupling member second position, in the first direction of the second coupling member 60, the projection 22 of the first coupling member 20 slides along the ramp 62 from the root 63 of the ramp 62 toward the edge 65 of the ramp 62. The projection 22 of the first coupling member 20 begins to move in the second direction of the first coupling member 20, due to the increasing angle of the ramp 62 from the root 63 of the ramp 62 to the edge 65 of the ramp 62.

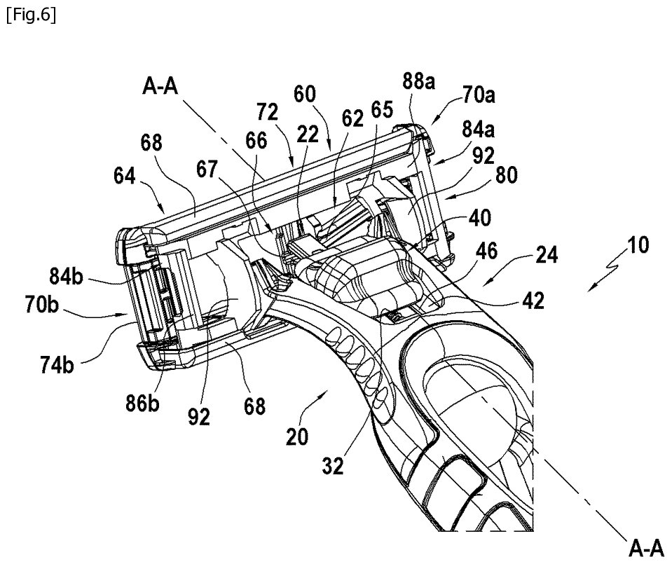

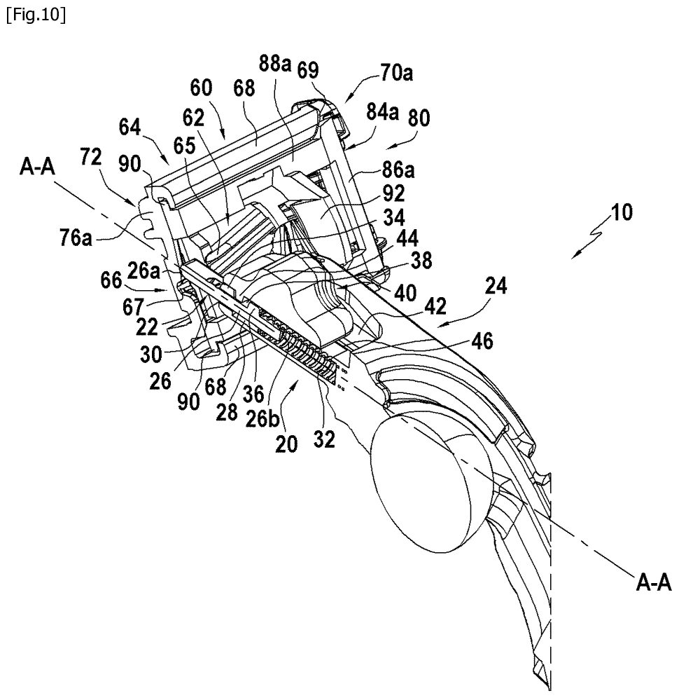

In examples and as shown in FIGS. 6 and 10, when the projection 22 of the first coupling member 20 reaches the edge 65 of the ramp 62 of the second coupling member 60, the first end 26a of the projection 22 slides off of the edge 65 of the ramp 62 and is no longer in contact with the ramp 62. It is contemplated that when the first end 26a of the projection 22 is capable of sliding off the edge 65 of the ramp 62, and is no longer in contact with the ramp 62, the first coupling member 20 is in the first coupling member first position and the second coupling member 60 is in the second coupling member second position. Accordingly, the projection 22 of the first coupling member 20 moves in the first direction of the first coupling member 20 and overshoots the ramp 62 of the second coupling member 60. In an example, in moving past the edge 65 of the ramp 62 of the second coupling member 60, the projection 22 of the first coupling member 20 is received by the recess 67 of the engagement member 66 of the second coupling member 60, thereby engaging the engagement member 66 of the second coupling member 60. In an example, in the first coupling member first position, with the projection 22 extended past the ramp 62 of the first coupling member 20, the body 26 of the projection 22 abuts the edge 65 of the ramp 62 in the second direction of second coupling member 60. In an example, it is contemplated that the second end 70b of the second coupling member 60 may include a stop (not shown) that is configured to abut the second end 84b of the third coupling member 80 to obstruct further movement of the second coupling member 60 in the first direction of the second coupling member 60. Accordingly, the second coupling member 60 is incapable of moving toward the second coupling member first position, in the second direction of the second coupling member 60. In this manner, the coupling between the first coupling member 20 and the second coupling member 60 is secured. Additionally, in this manner, the coupling between the second coupling member 60 and the third coupling member 80 is secured.

In examples and as illustrated by FIGS. 11-12, the user may decouple the second coupling member 60 from the first coupling member 20 and the third coupling member 80. To decouple the second coupling member 60 from the first coupling member 20 and the third coupling member 80, the user moves the button 40 in the second direction of the projection 22 of the first coupling member 20. Movement of the button 40 in the second direction of the projection 22 of the first coupling member 20 moves the projection 22 in the second direction of the first coupling member 20. As the projection 22 moves in the second direction of the first coupling member 20, the first end 26a of the projection 22 moves out of engagement with the engagement member 66 of the second coupling member 60. Additionally or alternatively, further movement of the projection 22 in the second direction of the first coupling member 20, causes the body 26 of the projection 22 to no longer abut the edge 65 of the ramp 62 of the second coupling member 60, as the projection 22 moves inwardly of the ramp 62 of the second coupling member 60. As movement of the second coupling member 60 in the second direction of the second coupling member 60 toward the second coupling member first position is no longer obstructed by the body 26 of the projection 22 of the first coupling member 20, the user is free to move the second coupling member 60 in the second direction of the second coupling member 60 until the second coupling member 60 is removed from the third coupling member 80. In this manner, the coupling mechanism 10 is capable of engaging and disengaging the head 110 of the shaving device 100 to and from the handle 120 of the shaving device 100, while reducing a number of components employed by the coupling mechanism 10, thereby also simplifying the functionality and/or manufacture of the coupling mechanism 10.

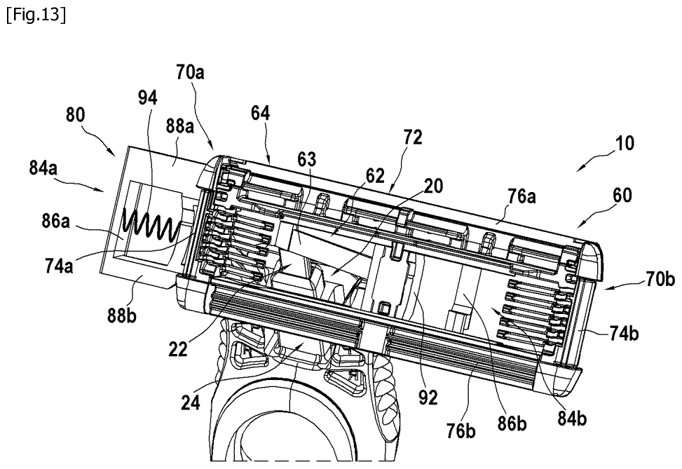

In examples and as shown in FIG. 13, it is contemplated that the third coupling member 80 may include a bias member 94 at the first end 84a of the third coupling member 80. The bias member 94 of the third coupling member 80 may be configured to bias the second coupling member 60 toward the second coupling member first position and/or toward the second direction of the second coupling member 60 when the second coupling member 60 is moved toward the second coupling member second position, in the first direction of the second coupling member 60, and/or when the second coupling member 60 is in the second coupling member second position. In this manner, removal of the second coupling member 60 from the third coupling member 80 and, thus, the head 110 from the handle 120 of the shaving device 100, may be facilitated and/or physically indicated for the user.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A coupling mechanism for a shaving device, the coupling mechanism comprising:
a first coupling member being configured to move between a first coupling member first position and a first coupling member second position; and
a second coupling member being configured to move relative to the first coupling member between a second coupling member first position and a second coupling member second position, and the second coupling member being configured to cause the first coupling member to move from the first coupling member first position toward the first coupling member second position when the second coupling member moves relative to the first coupling member from the second coupling member first position toward the second coupling member second position,
wherein, the first coupling member is configured to move from the first coupling member second position to the first coupling member first position when the second coupling member is in the second coupling member second position, and the first coupling member is configured to secure a coupling between the first coupling member and the second coupling member when the second coupling member is in the second coupling member second position and the first coupling member is in the first coupling member first position, wherein the second coupling member includes a ramp extending from a root to an edge, the ramp being configured to contact the first coupling member when the second coupling member moves relative to the first coupling member between the second coupling member first position and the second coupling member second position.

2. The coupling mechanism according to claim 1, wherein the first coupling member includes a bias member being configured to bias the first coupling member toward the first coupling member first position.

3. The coupling mechanism according to claim 1, wherein movement of the first coupling member along the ramp from the root toward the edge causes the first coupling member to move from the first coupling member first position toward the first coupling member second position.

4. The coupling mechanism according to claim 1, wherein the first coupling member is configured to abut the edge of the ramp to guide the coupling between the first coupling member and the second coupling member when the second coupling member is in the second coupling member second position and the first coupling member is in the first coupling member first position.

5. The coupling mechanism according to claim 1, wherein the second coupling member includes a frame comprising the ramp and the ramp extends from a surface of the frame toward a center of the frame.

6. The coupling mechanism according to claim 5, wherein the frame includes a leading surface and a trailing surface opposing the leading surface, the leading surface and the trailing surface are connected to each other by a first sidewall surface and a second sidewall surface, and the ramp is oriented at an angle within a range of 0 degrees and 50 degrees with respect to the first sidewall surface and/or the second sidewall surface.

7. The coupling mechanism according to claim 1, comprising a third coupling member configured to support the second coupling member.

8. The coupling mechanism according to claim 7, wherein the second coupling member is configured to move between the second coupling member first position and the second coupling member second position on the third coupling member.

9. The coupling mechanism according to claim 7, wherein the second coupling member includes a pair of opposing guide members, the third coupling member includes a pair of opposing flanges, and the pair of opposing guide members of the second coupling member are configured to engage the pair of opposing flanges of the third coupling member.

10. The coupling mechanism according to claim 7, wherein the third coupling member is pivotable with respect to the first coupling member.

11. The coupling mechanism according to claim 7, wherein the third coupling member includes a bias member being configured to bias the second coupling member toward the second coupling member first position.

12. The coupling mechanism according to claim 1, wherein the second coupling member includes an engagement member being configured to engage the first coupling member when the first coupling member is in the first coupling member first position and the second coupling member is in the second coupling member second position.

13. The coupling mechanism according to claim 1, comprising a button being configured to be manipulated by a user and to move the first coupling member between the first coupling member first position and the first coupling member second position.

14. A shaving device comprising:
the coupling mechanism according to claim 1;
a shaving head; and
a handle;
wherein, the handle includes the first coupling member of the coupling mechanism and the shaving head includes the second coupling member of the coupling mechanism.
